(19) United States
(12) Patent Application Publication
(10) Pub. No.: US 2010/0024984 A1
(43) Pub. Date: Feb. 4, 2010

(54) LOW-VOLTAGE ELECTRIC APPARATUS WITH ONE LABELING POSITION

(75) Inventor: Ambroise Mercier-Gallay, Villeurbanne (FR)

Correspondence Address: CANTOR COLBURN, LLP, 20 Church Street, 22nd Floor, Hartford, CT, 06103, US

(73) Assignee: ABB FRANCE, Rueil-Malmaison (FR)

(21) Appl. No.: 12/529,277

(22) PCT Filed: Feb. 11, 2008
(86) PCT No.: PCT/FR2008/000170

§ 371 Date: Oct. 2, 2009

(30) Foreign Application Priority Data
Mar. 7, 2007 (FR) 0701651

(51) Int. Cl. B65C 9/26

(52) U.S. Cl. 156/391

(57) ABSTRACT

The low-voltage electric apparatus with at least one labelling position (3) as per the invention has an insulating body (2) comprising the labelling position (3), numbering at least one, said position (3) including fastening means (6) for a labelling element (4). The labelling position (3) includes a marking zone (5) located in relation to the outside of the insulating body (2) to the front or substantially at the same level as the most advanced portion of the fastening means (6).

### TECHNICAL FIELD OF THE INVENTION

The present invention relates to a low-voltage electrical apparatus comprising at least one labeling position.

### BRIEF DESCRIPTION OF RELATED ART

As is known, such an apparatus comprises an insulating body comprising at least one labeling position, this position including means of fixing a labeling element.

The labeling positions of known type, for example from the document DE202004010070, make it possible to add a labeling element and fix it to apply a marking to the apparatus.

It appears however that, if the user does not have a labeling element available that is of a type suited to the labeling position, he cannot proceed with marking the apparatus.

The aim of the present invention is to remedy this drawback, by proposing a low-voltage apparatus whose marking is made easier.

### BRIEF SUMMARY OF THE INVENTION

To this end, the subject of the present invention is a low-voltage apparatus of the abovementioned type, characterized in that the labeling position comprises a marking area located relative to the outside of the insulating body to the front or substantially in the same plane as the most advanced portion of the fixing means.

Thanks to the provisions of the invention, it is possible to proceed with the marking of the low-voltage apparatus by adding a labeling element suited to the fixing means, but also to proceed with the marking by adding an inscription to the marking area, or by fixing a label to the marking area, for example by gluing, by easily accessing the marking area.

Preferably, the fixing means comprise at least two fixing members, the marking area being located between the two fixing members.

Advantageously, inclined guiding portions are provided on the lateral edges of the marking area to facilitate the cutting of a strip fixed to the marking area.

These provisions make it possible, for example, to glue an adhesive strip to a set of apparatuses positioned side by side on a rail, then to cut the strip easily to individualize these apparatuses, the cutting tool being guided by the guiding means between the walls of two adjacent electrical apparatuses.

Preferably, the marking area is a substantially flat area.

Advantageously, the fixing members include a recess provided with retaining means arranged on one edge of the recess located to the side of the center of the fixing position relative to the recess.

These provisions make it possible on the one hand to facilitate snap-fitting and on the other hand to reduce the bulk of the labeling position. It is sufficient in practice to press in the center of the labeling element for the tabs of the labeling element of a form that complements the recess to separate and be folded back into the recess.

Preferably, the fixing members located either side of the marking area include asymmetrical lateral end-stops.

These provisions make it possible to ensure that the labeling element is secured laterally while making it possible to remove the latter easily by a rotational movement.

Advantageously, the marking area has a width greater than 5 mm, and preferably greater than 9 mm.

These provisions make it possible to ensure that there is a sufficient surface area to provide a marking or to glue onto the marking area.

In any case, the invention will be clearly understood from the following description, given with reference to the appended diagrammatic drawing which represents, by way of non-limiting example, one embodiment of this module and of this assembly.

### BRIEF DESCRIPTION OF THE DRAWINGS

FIG. 1 is a partial cross-sectional view of a portion of an apparatus according to the invention including a labeling position.

FIG. 2 is a detailed view of FIG. 1, on a larger scale.

FIG. 3 is a plan view of the labeling position of FIG. 1.

### DETAILED DESCRIPTION OF THE INVENTION

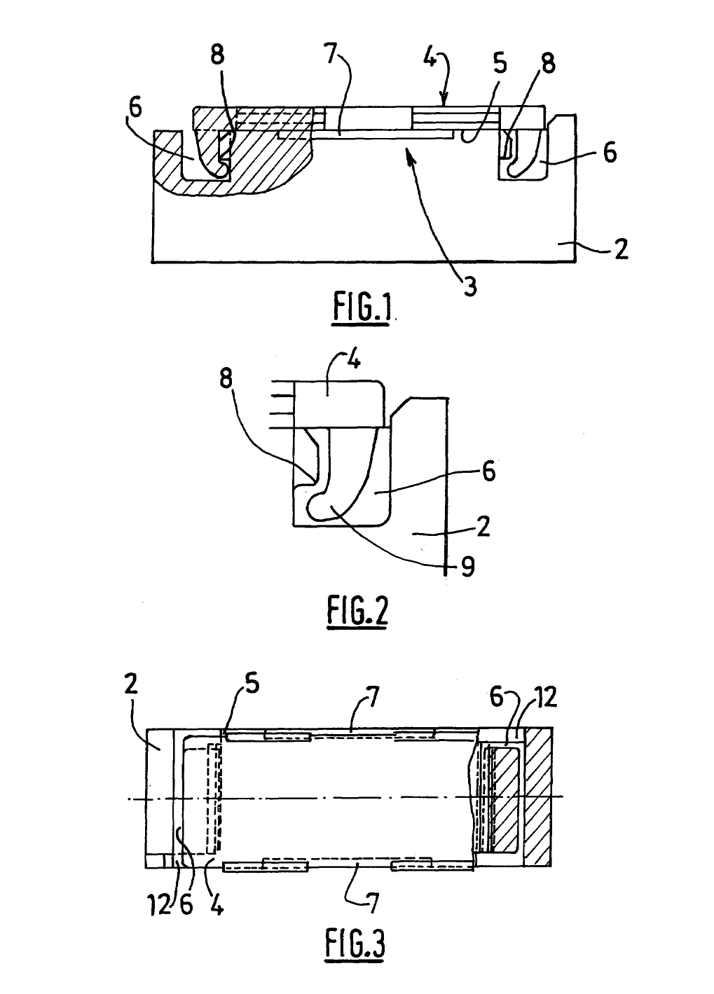

According to an embodiment represented in FIGS. 1 to 3, a low-voltage electrical apparatus comprises an insulating body 2 with at least one position 3 for fixing a labeling element 4.

The labeling position includes a flat marking area 5 located between two fixing members 6, this area being located to the front or substantially in the same plane as the most advanced portion of the fixing members 6.

The marking area has a width of the order of 1 cm.

Inclined guiding portions 7 are provided on the lateral edges of the marking area to facilitate the cutting of a strip fixed to the marking area 5.

The fixing members 6 comprise recesses formed by two cavities including a retaining edge 8, designed to receive elastic fixing tabs 9 of the labeling element 4 that can cooperate with the retaining edge 10, located either side of this labeling element 4.

The retaining edge 8 is located on one edge of the cavity 6 located to the side of the center of the labeling position relative to the cavity. The cavities located on both sides of the position are respectively delimited by asymmetrical lateral end-stops 12.

Obviously, the invention is not limited to the single embodiment of this apparatus described hereinabove by way of example, but, on the contrary, encompasses all the variants.

1. A low-voltage electrical apparatus with at least one labeling position, comprising:
an insulating body with at least one labeling position, this position comprising means of fixing a labeling element,
wherein the labeling position comprises a marking area located relative to an outside of the insulating body to a front or substantially in a same plane as a most advanced portion of the fixing means.

2. The apparatus as claimed in claim 1, wherein the fixing means comprise at least two fixing members, the marking area being located between the two fixing members.

3. The apparatus as claimed in claim 1, wherein inclined guiding portions are provided on lateral edges of the marking area to facilitate cutting of a strip fixed to the marking area.

4. The apparatus as claimed in claim 1, wherein the marking area is a substantially flat area.

5. The apparatus as claimed in claim 2, wherein the fixing members include a recess provided with retaining means arranged on one edge of the recess located to a side of a center of the fixing position relative to the recess.

6. The apparatus as claimed in claim 2, wherein the fixing members located either side of the marking area comprise asymmetrical lateral end-stops.

7. The apparatus as claimed in claim 1, wherein the marking area has a width greater than 5 mm.

8. The apparatus as claimed in claim 3, wherein the fixing members include a recess provided with retaining means arranged on one edge of the recess located to a side of a center of the fixing position relative to the recess.

9. The apparatus as claimed in claim 4, wherein the fixing members include a recess provided with retaining means arranged on one edge of the recess located to a side of a center of the fixing position relative to the recess.

10. The apparatus as claimed in claim 3, wherein the fixing members located either side of the marking area comprise asymmetrical lateral end-stops.

11. The apparatus as claimed in claim 4, wherein the fixing members located either side of the marking area comprise asymmetrical lateral end-stops.

12. The apparatus as claimed in claim 5, wherein the fixing members located either side of the marking area comprise asymmetrical lateral end-stops.

13. The apparatus as claimed in claim 1, wherein the marking area has a width greater than 9 mm.
